(19) United States
(12) Patent Application Publication
(10) Pub. No.: US 2023/0114941 A1
(43) Pub. Date: Apr. 13, 2023

(54) DOUBLE-SIDED PAD CONDITIONER

(71) Applicant: ENTEGRIS, INC., Billerica, MA (US)

(72) Inventors: Doruk Yener, Bedford, MA (US); Joseph Rivers, Austin, TX (US); Elango Balu, North Reading, MA (US); Fadi Abdallah Coder, Chandler, AZ (US)

(21) Appl. No.: 17/950,809

(22) Filed: Sep. 22, 2022

Related U.S. Application Data
(60) Provisional application No. 63/249,679, filed on Sep. 29, 2021.
(60) Provisional application No. 63/311,714, filed on Feb. 18, 2022.

(51) Int. Cl. B24B 53/017

(52) U.S. Cl. CPC B24B 53/017

(57) ABSTRACT

A CMP pad conditioner assembly includes a backing plate including a first face including a plurality of first mounting locations and a second face including a plurality of second mounting locations. A plurality of segments is secured to the first face. The segments include a substrate having a first surface and a second surface opposite the first surface. A plurality of protrusions is integral with the substrate protruding away from the first surface. The protrusions are coated with a conformal diamond layer. A plurality of second segments is secured to the second face, the second segments including a substrate having a first surface and a second surface opposite the first surface. Each of the second segments includes a plurality of protrusions integral with the substrate protruding away from the first surface. The protrusions are coated with a conformal diamond layer.

### CROSS-REFERENCE TO RELATED APPLICATIONS

This application claims the benefit under 35 USC 119 of U.S. Provisional Pat. Application Nos. 63/249,679, filed Sep. 29, 2021, and 63/311,714 filed on Feb. 18, 2022, the disclosure of each is hereby incorporated herein by reference in its entirety.

### FIELD

This disclosure relates generally to equipment for manufacturing semiconductors. More particularly, this disclosure relates to a double-sided segment for chemical mechanical planarization (CMP).

### BACKGROUND

Chemical mechanical planarization or chemical mechanical polishing (CMP) can be part of the manufacturing process for semiconductor devices. During CMP, material is removed from a wafer substrate via a polishing pad and a polishing slurry. CMP can optionally include one or more chemical reagents. Over time, the polishing pad can become matted and filled with debris. A segment can be used to recondition the polishing pad.

### SUMMARY

In some embodiments, a chemical mechanical planarization (CMP) pad conditioner assembly includes a backing plate. In some embodiments, the backing plate includes a first face and a second face. In some embodiments, the first face includes a plurality of first mounting locations. In some embodiments, the second face includes a plurality of second mounting locations. In some embodiments, a plurality of segments is secured to the first face at the plurality of first mounting locations. In some embodiments, each of the plurality of segments includes a substrate having a first surface and a second surface. In some embodiments, the first surface is opposite the second surface. In some embodiments, a plurality of protrusions is integral with the substrate protruding away from the first surface. In some embodiments, the plurality of protrusions is coated with a conformal diamond layer. In some embodiments, a plurality of second segments is secured to the second face at the plurality of second mounting locations. In some embodiments, each of the plurality of second segments includes a substrate having a first surface and a second surface. In some embodiments, the first surface is opposite the second surface. In some embodiments, each of the plurality of second segments includes a plurality of protrusions integral with the substrate protruding away from the first surface. In some embodiments, the plurality of protrusions is coated with a conformal diamond layer.

In some embodiments, the backing plate includes stainless steel. In some embodiments, the backing plate includes a polymer. In some embodiments, the backing plate is made from an additive manufacturing process. In some embodiments, the backing plate is injection molded. In some embodiments, the polymer includes metallic particulate fillers.

In some embodiments, one or more of the first plurality of mounting locations or the second plurality of mounting locations are recessed into the backing plate.

In some embodiments, the first plurality of segments and the second plurality of segments are the same.

In some embodiments, the first plurality of mounting locations and the second plurality of mounting locations are aligned to be the same on opposite sides of the backing plate.

In some embodiments, a CMP pad conditioner assembly includes a backing plate. In some embodiments, the backing plate includes a first face and a second face. In some embodiments, the backing plate includes a plurality of mounting locations. In some embodiments, a plurality of segments is secured to the backing plate at the plurality of mounting locations. In some embodiments, each of the plurality of segments includes a substrate having a first surface and a second surface. In some embodiments, the first surface is opposite the second surface. In some embodiments, a plurality of protrusions is integral with the substrate and protruding away from the first surface. In some embodiments, the plurality of protrusions is coated with a conformal diamond layer. In some embodiments, a second plurality of protrusions protrudes away from the second surface. In some embodiments, the second plurality of protrusions is coated with a conformal diamond layer.

In some embodiments, one or more of the first plurality of mounting locations or the second plurality of mounting locations are recessed into the backing plate and comprise a well recessed into the backing plate.

In some embodiments, the well comprises one or more surface modifications.

In some embodiments, the backing plate includes stainless steel. In some embodiments, the backing plate includes a polymer. In some embodiments, the backing plate is made from an additive manufacturing process.

In some embodiments, the plurality of mounting locations are apertures in the backing plate.

In some embodiments, each of the plurality of segments is the same.

In some embodiments, a method includes obtaining a backing plate. In some embodiments, the backing plate includes a first face and a second face. In some embodiments, the first face includes a plurality of first mounting locations. In some embodiments, the second face includes a plurality of second mounting locations. In some embodiments, the method includes obtaining a plurality of segments. In some embodiments, the plurality of segments includes a substrate having a first surface and a second surface. In some embodiments, the first surface is opposite the second surface. In some embodiments, a plurality of protrusions is integral with the substrate protruding away from the first surface. In some embodiments, the plurality of protrusions is coated with a conformal diamond layer. In some embodiments, the method includes securing a first subset of the plurality of segments to the plurality of first mounting locations. In some embodiments, the method includes securing a second subset of the plurality of segments to the plurality of second mounting locations.

In some embodiments, securing the first subset of the plurality of segments includes aligning the first subset of the plurality of segments on a mounting guide. In some embodiments, securing the subset of the plurality of segments includes applying an adhesive to the second surface of the first subset of the plurality of segments. In some embodiments, securing the first subset of the plurality of segments includes applying a force to the second face of the backing plate.

In some embodiments, securing the second subset of the plurality of segments is completed after the securing the first subset of the plurality of segments to the plurality of first mounting locations.

In some embodiments, securing the second subset of the plurality of segments includes aligning the second subset of the plurality of segments on a mounting guide. In some embodiments, securing the second subset of the plurality of segments includes applying an adhesive to the second surface of the second subset of the plurality of segments. In some embodiments, securing the second subset of the plurality of segments includes applying a force to the second surface of the backing plate. In some embodiments, a guide plate is disposed between the backing plate and a surface applying the force to the second surface of the backing plate to prevent contact with the surface applying the force to the second surface of the backing plate and the first subset of the plurality of segments.

In some embodiments, a mounting guide is used for securing the first subset of the plurality of segments and the second subset of the plurality of segments so that the first subset of the plurality of segments and the second subset of the plurality of segments are installed in a same location on opposite surfaces of the backing plate.

### BRIEF DESCRIPTION OF THE DRAWINGS

References are made to the accompanying drawings that form a part of this disclosure and that illustrate embodiments in which the systems and methods described in this Specification can be practiced.

FIG. 1A shows a top view of a double-sided pad conditioner assembly, according to some embodiments.

FIG. 1B shows a bottom view of the double-sided pad conditioner assembly of FIG. 1A, according to some embodiments.

FIG. 2A and FIG. 2B show side views of a portion of the double-sided pad conditioner assembly, according to different embodiments.

FIG. 3 shows a side view of a portion of the double-sided pad conditioner assembly of FIG. 1A, according to some embodiments.

FIG. 4 shows a side view of a portion of the double-sided pad conditioner assembly of FIG. 1A, according to other embodiments.

FIG. 5 shows a side view of a portion of the double-sided pad conditioner assembly of FIG. 1A, according to yet other embodiments.

FIG. 6 shows a side view of a portion of the double-sided pad conditioner assembly of FIG. 1A, according to some embodiments.

FIG. 7 shows a flowchart of a method for manufacturing the double-sided pad conditioner assembly of FIG. 1A, according to some embodiments.

Like reference numbers represent the same or similar parts throughout.

### DETAILED DESCRIPTION

During the microelectronic device fabrication process, multiple integrated circuits are formed upon the surface of substrate. Examples of substrates include silicon wafers, gallium arsenide wafers, and the like. Each integrated circuit consists of microelectronic devices electrically interconnected with conductive traces known as interconnects. Interconnects are patterned from conductive layers formed on the surface of the substrate. The ability to form stacked layers of interconnects has allowed for more complex microelectronic circuits to be implemented in and on relatively small surface areas of the substrate. With the number of microelectronic circuits increasing and becoming more complex, the number of layers of a substrate is increasing. Accordingly, planarity of the substrate surface becomes an important aspect in semiconductor manufacturing.

Chemical mechanical planarization (CMP) is a method of planarizing the surface of a layer of a substrate. CMP combines chemical etching and mechanical abrasion to remove material from the surface of the substrate. During the CMP process, the substrate is attached to the head of a polishing tool and is inverted such that the surface having the integrated circuit faces a polishing pad. A slurry containing abrasive particles and a chemical etchant is deposited onto the rotating polishing pad. The chemicals can soften or react with the exposed surface material on the substrate that is being planarized. The polishing pad is fixedly attached to a turntable or platen. The substrate is polished by placing the rotating substrate into contact with the polishing pad while the polishing pad is rotated on the platen. The surface of the integrated circuit-embedded surface of the substrate can be removed by the combined action of chemical softening of the exposed surface material and physical abrasion brought about by relative movement between the polishing pad, the slurry, and the substrate.

As portions of the substrate are removed by the polishing pad, a combination of slurry and debris tends to clog and glaze the surface of the polishing pad, such that over time, the polishing pad becomes less effective at removing material from the substrate. The surface of the polishing pad is cleaned or conditioned by a CMP pad conditioning assembly, which has an abrasive surface that engages the polishing pad surface. Known CMP pad conditioning assemblies can have an abrasive surface that includes protrusions, mesas, or cutting edges and these may be coated with hard coatings like cubic boron nitride, diamond grit, or polycrystalline diamond. The abrasive surface of the pad conditioning assembly can itself become worn thereby rendering it less effective over time for reconditioning the CMP polishing pad. During conditioning of the CMP polishing pad, the pad conditioning assembly abrades the CMP pad and opens new pores and a fresh pad surface for polishing.

The CMP process utilizes many consumables including the slurry and chemicals, the polishing pad, and the pad conditioning assembly. Replacing consumables can be time consuming and result in lost manufacturing yield and reduced wafer throughput.

Embodiments provide a double-sided pad conditioner assembly. Double-sided pad conditioners are capable of polishing on two surfaces at a same time, instead of a single surface.

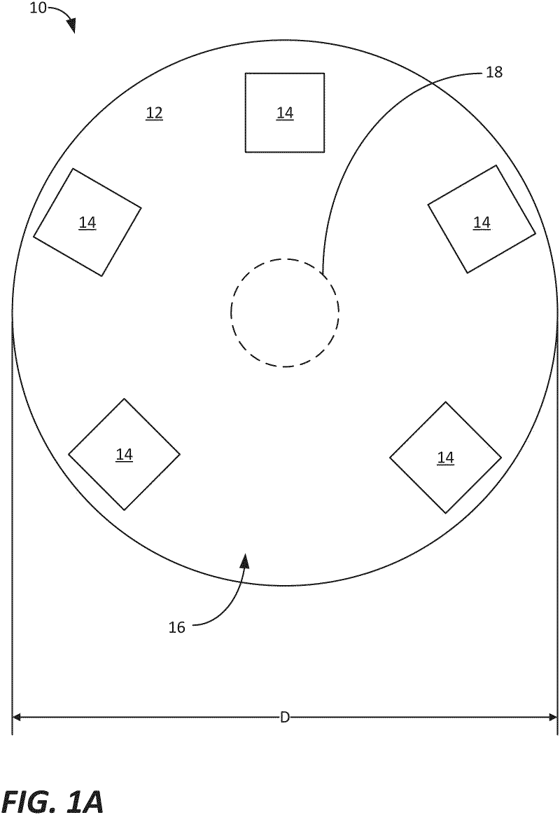

FIG. 1A shows a top view of a double-sided pad conditioner assembly 10, according to some embodiments. The double-sided pad conditioner assembly 10 is configured to be capable of polishing via both sides of the double-sided pad conditioner assembly 10 simultaneously.

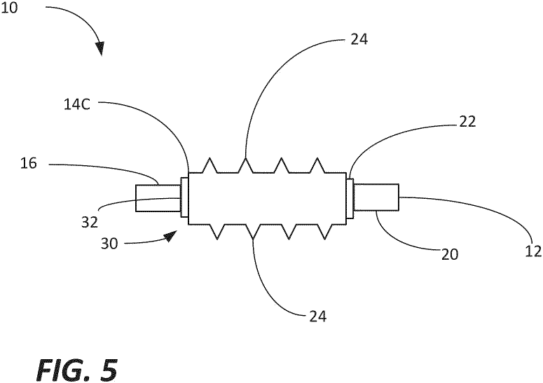

In some embodiments, the double-sided pad conditioner assembly 10 includes a backing plate 12 and a plurality of segments 14. The segments 14 are secured to the backing plate 12. The backing plate 12 has a first face 16. In some embodiments, the segments 14 are secured to the first face 16. In some embodiments, the backing plate 12 includes a plurality of apertures through the backing plate 12, and the segments 14 are secured within the apertures to the backing plate 12. Such embodiments are shown and described in additional detail in accordance with FIG. 5 below.

In some embodiments, the backing plate 12 has a disc-shape. In some embodiments, a shape of the backing plate 12 can be other than disc-shaped (e.g., square, rectangular, triangular, or the like).

In some embodiments in which the backing plate 12 is disc-shaped, the backing plate 12 can have a diameter D. In some embodiments, the diameter D can be from 3 inches to 13 inches. In some embodiments, the diameter D can be from 3 inches to 12 inches. In some embodiments, the diameter D can be from 3 inches to 11 inches. In some embodiments, the diameter D can be from 3 inches to 10 inches. In some embodiments, the diameter D can be from 3 inches to 9 inches. In some embodiments, the diameter D can be from 3 inches to 8 inches. In some embodiments, the diameter D can be from 3 inches to 7 inches. In some embodiments, the diameter D can be from 3 inches to 6 inches. In some embodiments, the diameter D can be from 3 inches to 5 inches. In some embodiments, the diameter D can be from 3 inches to 4 inches. In some embodiments, the diameter D can be from 4 inches to 13 inches. In some embodiments, the diameter D can be from 5 inches to 13 inches. In some embodiments, the diameter D can be from 6 inches to 13 inches. In some embodiments, the diameter D can be from 7 inches to 13 inches. In some embodiments, the diameter D can be from 8 inches to 13 inches. In some embodiments, the diameter D can be from 9 inches to 13 inches. In some embodiments, the diameter D can be from 10 inches to 13 inches. In some embodiments, the diameter D can be from 11 inches to 13 inches. In some embodiments, the diameter D can be from 12 inches to 13 inches.

It is to be appreciated that the above ranges are examples and the actual diameter D can vary beyond the stated ranges in accordance with the present description. In some embodiments in which the shape of the backing plate 12 is other than disc-shaped, the diameter D can be representative of a major dimension of the backing plate 12.

In some embodiments, the backing plate 12 can be made of a polymer material. For example, in some embodiments, the polymer material can be acrylonitrile butadiene styrene (ABS); polycarbonate; polyester; nylon (PA6, PA66, etc.); polyvinyl chloride (PVC); polypropylene (PP); polyethylene terephthalate (PET); polyether ether ketone (PEEK); polyether ketone (PEK); polytetrafluoroethylene (PTFE); or any combination thereof. In some embodiments, the backing plate 12 can be made of a material that is chemically compatible with the CMP process chemicals and slurry. In some embodiments, the backing plate 12 can be chemically passivated. In some embodiments, the polymer material may not need to be chemically passivated. In such embodiments, the backing plate 12 can be cheaper to manufacture than current backing plates requiring chemical passivation. In some embodiments, the backing plate 12 can be made of stainless steel or the like.

In some embodiments, the backing plate 12 can include one or more fillers along with the polymer. For example, in some embodiments, a pigment filler can be included. In such embodiments, different pigment fillers or colorant fillers can be used to identify a particular backing plate 12 for a particular application. In some embodiments, the one or more fillers can include a metallic particulate filler material embedded within the polymer. The metallic particulate filler material can, for example, be used to provide additional structural integrity to the backing plate 12.

In some embodiments, the backing plate 12 can be produced by an additive manufacturing process. For example, in some embodiments, the backing plate 12 can be produced by 3D printing. In such embodiments, different layers of the 3D printed backing plate 12 can be formed of different materials (e.g., to include a metallic layer or the like). In some embodiments, the different layers of the 3D printed backing plate 12 can be formed of the same material.

In some embodiments, the backing plate 12 can be produced by injection molding.

In some embodiments, the backing plate 12 includes the plurality of segments 14. The plurality of segments 14 can be secured to the backing plate 12 with an adhesive. In some embodiments, suitable adhesives include, but are not limited to, epoxies, tape adhesives, any combination thereof, or the like.

In the illustrated embodiment, five of the segments 14 are shown. It is to be appreciated that the number of the segments 14 can vary. For example, in some embodiments, the number of segments 14 can be less than five. In some embodiments, the number of segments 14 can be greater than five. A number of segments 14 may be selected based on a particular application or the like.

In some embodiments, each of the segments 14 generally provides an abrasive region. The abrasive regions collectively contact a polishing pad used in CMP when reconditioning the polishing pad using the double-sided pad conditioner assembly 10. The abrasive region is generally defined by a plurality of contact surfaces.

The various features of the segments 14 can be configured depending upon the application of the polishing pad being reconditioned using the double-sided pad conditioner assembly 10. For example, at least one of a relative size of the segments 14; a number of segments 14; a feature density on the segments 14; a depth of the features on the segments 14; any combination thereof; or the like, can be selected based on the application of the polishing pad to be reconditioned.

In the illustrated embodiment, the segments 14 are generally square-shaped when viewed from the top view. As used herein, “generally square-shaped” means square-shaped subject to manufacturing tolerances or the like. That is, the length and the width of the segments 14 is substantially the same subject to manufacturing tolerances or the like. In some embodiments, the geometry of the segments 14 can be a shape other than square. The segments 14 can include rounded corners and chamfered edges to, for example, minimize an accumulation of material and to, for example, reduce scratching resulting from this accumulation. In some embodiments, the segments 14 can be rectangular or the like.

In some embodiments, the location of the segments 14 on the backing plate 12 can be varied. In some embodiments, the spacing can be selected so that an arc length between each of the segments 14 is the same or substantially the same. As used herein, substantially the same means the same subject to manufacturing tolerances or the like. In some embodiments, the spacing can be selected so that the arc length between the segments 14 is not the same. In some embodiments, the locations of the segments 14 can be selected so that vibration of the double-sided pad conditioner assembly 10 is reduced when in use.

In some embodiments, the backing plate 12 can include an aperture 18. The aperture 18 is illustrated in dashed lines because the aperture 18 is optional. The aperture 18 can be referred to as a finger hole. That is, the aperture 18 can be used to enable the double-sided pad conditioner assembly 10 to be handled by an operator. In some embodiments, the aperture 18 can be used to enable handling the double-sided pad conditioner assembly 10 by other equipment.

FIG. 1B shows a bottom view of the double-sided pad conditioner assembly 10, according to some embodiments.

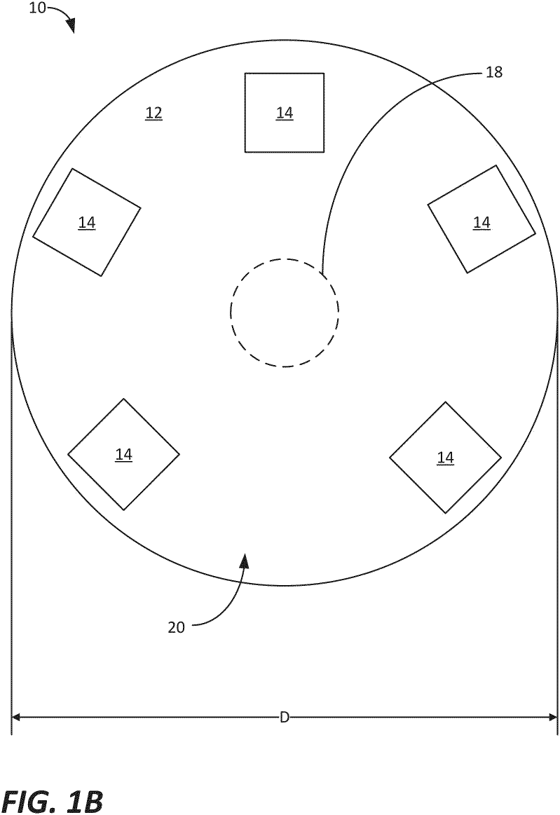

The backing plate 12 has a second face 20. The second face 20 is opposite the first face 16. As illustrated, in some embodiments, segments 14 are arranged on the second face 20. For example, segments 14 may be in the same locations as the segments 14 were secured to the first face 16 (FIG. 1A). That is, some or all of the segments on the second face 20 may be positioned directly opposite to segments on the first face 16, as shown in FIG. 2A in which segments 14A are opposite segments 14B. As a specific example, each of the segments on the second face may be positioned opposite to each segment on the first face. Alternatively, in some embodiments, segments 14 are arranged on the second face 20 in different locations than the segments 14 were secured to the first face 16 (FIG. 1A). That is, in some embodiments, the segments 14 on the first face 16 (FIG. 1A) and the segments 14 on the second face 20 can be offset from each other, as shown in FIG. 2B in which segments 14A and 14B are in an alternating staggered arrangement. In some embodiments, some of the segments 14 on the first face 16 (FIG. 1A) can be offset or in different locations than the segments 14 on the second face 20 and others of the segments 14 can be in the same locations. In some embodiments, the segments 14 extend through an aperture in the backing plate 12. In such embodiments, the segments 14 are secured within the apertures of the backing plate 12.

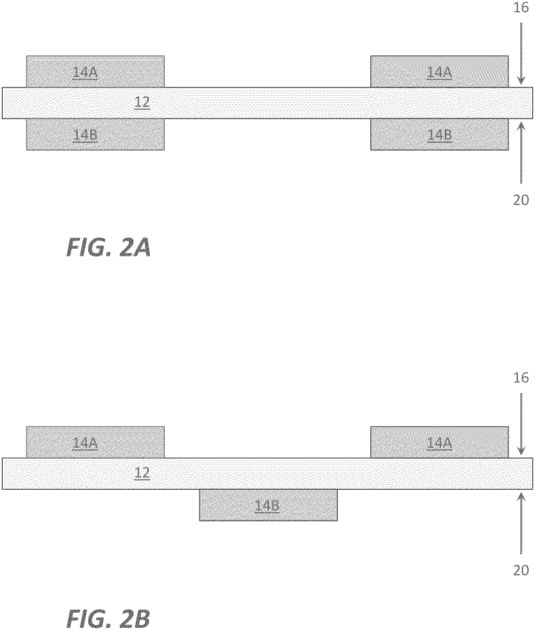

FIG. 3 shows a side view of the double-sided pad conditioner assembly 10, according to some embodiments. For simplicity of this Specification, features previously described will not be described in additional detail unless specific reference is made.

In the embodiment illustrated in FIG. 3, segments 14A are secured to the first face 16 via adhesive 22 and segments 14B are secured to the second face 20 via adhesive 22. The segments 14A and the segments 14B are collectively referenced as the segments 14 unless specific reference is made otherwise.

In some embodiments, the segments 14 can include a core and one or more additional layers. The core can be, for example, a porous silicon carbide or the like. A surface layer is disposed on the core. In some embodiments, the surface layer can be a silicon carbide surface layer added to the core via, for example, a chemical vapor deposition (CVD) process. The surface layer can be etched (e.g., via a laser or the like) to create a plurality of surface features. The surface layer includes a hardened layer. The hardened layer can be, for example, a diamond coating that can be added as a conformal layer to the surface layer via, for example, a CVD process.

In some embodiments, the segments 14 provide the abrasion surface on the double-sided pad conditioner assembly 10. As such, when reconditioning a polishing pad for a CMP tool, the surface features contact the polishing pad. In some embodiments, the core and surface layer can collectively be referred to as a substrate.

In some embodiments, the segments 14 include a plurality of protrusions 24. The protrusions 24 protrude away from the backing plate 12. For example, the protrusions 24 on the segments 14A protrude away from the first face 16 and the protrusions 24 on the segments 14B protrude away from the second face 20. The protrusions 24 may include a hardened layer, such as a diamond coating that can be added as a conformal layer to the protrusions via, for example, a CVD process.

In some embodiments, the protrusions 24 can be conical, frustoconical, a combination thereof, or the like. Other geometries for the protrusions 24 may be selected. In some embodiments, a first of the protrusions 24 can extend a first distance from the backing plate 12, while a second of the protrusions 24 can extend a second distance from the backing plate 12, the second distance being different from the first distance. In some embodiments, the first distance and the second distance can be the same.

In some embodiments, the backing plate 12 can include a textured surface 26. For illustrative purposes, the textured surface 26 is shown by stippling in the figures. The textured surface 26 can promote better adhesion of the segments 14 to the backing plate 12. In some embodiments, the segments 14 can be secured to the backing plate 12 at a plurality of mounting locations 28 defined by the textured surface 26 by the adhesive 22. In some embodiments, the adhesive 22 can include epoxies, tape adhesives, any combination thereof, or the like.

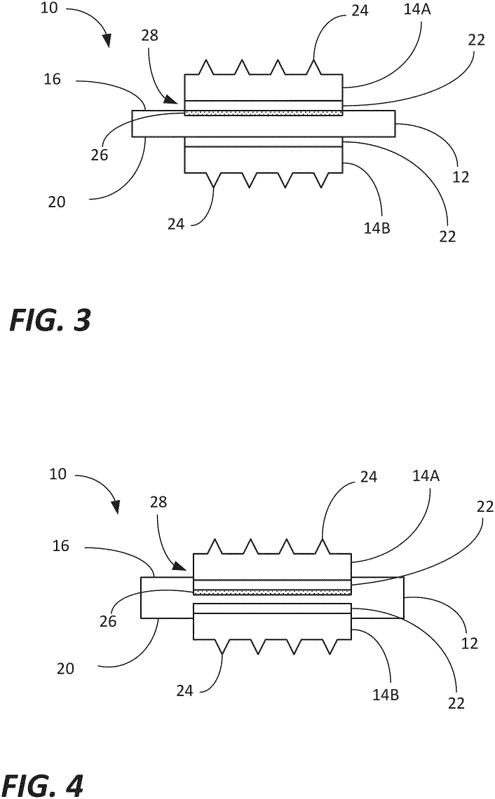

FIG. 4 shows a side view of the double-sided pad conditioner assembly 10, according to other embodiments. For simplicity of this Specification, features previously described will not be described in additional detail unless specific reference is made.

In the embodiment illustrated in FIG. 4, segments 14A are recessed into the first face 16 and segments 14B are recessed into the second face 20. The embodiment of FIG. 4 may be useful when, for example, an overall thickness of the double-sided pad conditioner assembly 10 is limited (e.g., based on the equipment used or the like).

FIG. 5 shows a side view of the double-sided pad conditioner assembly 10, according to yet other embodiments. For simplicity of this Specification, features previously described will not be described in additional detail unless specific reference is made.

In the embodiment illustrated in FIG. 5, segment 14C is disposed within an aperture 30 and secured by adhesive 22 to the backing plate 12 at walls 32 forming the aperture 30. The segment 14C is a double-sided segment. As a result, unlike the embodiments of FIGS. 3-4, the embodiment of FIG. 5 can include a single segment 14C that extends through the backing plate 12 instead of segment 14A on the first face 16 and segment 14B on the second face 20. In some embodiments, the segment 14C can alternatively be segment 14A secured to segment 14B to create the double-sided segment 14C. In some embodiments, the segment 14C can be made in the same manner as discussed above with respect to FIGS. 3-4 but have the protrusions 24 formed on both sides of the core.

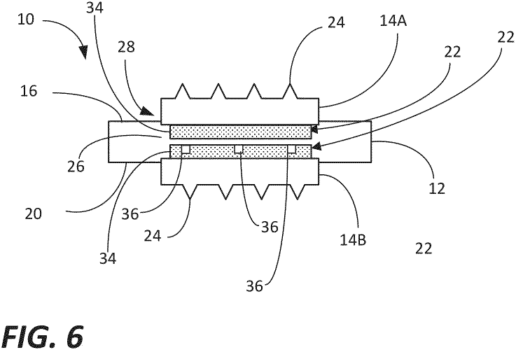

FIG. 6 shows a side view of a portion of the double-sided pad conditioner assembly 10 of FIG. 1, according to some embodiments. For simplicity of this Specification, features previously described will not be described in additional detail unless specific reference is made.

In the embodiment illustrated in FIG. 6, segments 14A are recessed into the first face 16 and segments 14B are recessed into the second face 20. Additionally, the first face 16 and the second face 20 include a well 34 in the recessed portion of the first face 16 and the second face 20.

In some embodiments, the well 34 is dimensionally smaller than the segments 14A and the segments 14B. For example, in some embodiments, the surface area of the well 34 is up to 99% of the surface area of the segments 14A or the segments 14B. In some embodiments, the surface area of the well 34 is at least 1% of the surface area of the segments 14A or the segments 14B. In some embodiments, the surface area of the well 34 is up to 95% of the surface area of the segments 14A or the segments 14B. In some embodiments, the surface area of the well 34 is up to 90% of the surface area of the segments 14A or the segments 14B. In some embodiments, the surface area of the well 34 is at least 50% of the surface area of the segments 14A or the segments 14B.

The well 34 is configured to receive the adhesive 22. In the illustrated embodiment, for simplicity of this Specification, the adhesive 22 is shown in the well 34 with stippling. In some embodiments, the well 34 can be dimensioned to provide a thickness of the adhesive 22 of at least 100 µm. In some embodiments, the well 34 can be dimensioned to provide a thickness of the adhesive 22 of at least 110 µm. In some embodiments, the well 34 can be dimensioned to provide a thickness of the adhesive 22 of at least 120 µm. In some embodiments, a thickness of the adhesive 22 is up to 150 µm.

In some embodiments, as shown for segments 14B, one or more surface modifications 36 can be disposed within the well 34. It is to be appreciated that the well 34 for the segments 14A can also include the one or more surface modifications 36. In some embodiments, the one or more surface modifications 36 can be included in the well 34 on both surfaces of the double-sided pad conditioner assembly 10. In some embodiments, the one or more surface modifications 36 can be included on one of the surface of the double-sided pad conditioner assembly 10. In some embodiments, the one or more surface modifications 36 may not be included, but instead a surface of the well 34 can be modified (e.g., abraded or the like) to provide a surface roughness. The one or more surface modifications 36 or the surface roughness of the well 34 can provide additional surface area for the adhesive 22.

In the illustrated embodiment, the one or more surface modifications 36 are shown as including three of the one or more surface modifications 36. It is to be appreciated that this is an example and the actual number can vary below three or greater than three. In some embodiments, the one or more surface modifications 36 includes a single surface modification. In some embodiments, the one or more surface modifications 36 can alternatively be described as one or more ribs or the like.

In the illustrated embodiment, the one or more surface modifications 36 are rectangular in geometry. It is to be appreciated that this geometry is an example, and that other geometries are possible within the scope of this disclosure. For example, in some embodiments, the one or more surface modifications 36 can be pyramid shaped, semicircular, cylindrical, or other geometries capable of increasing the surface area for the adhesive 22.

As shown in the illustrated embodiment, the one or more surface modifications 36 have a height that is smaller than a depth of the well 34. As a result, in some embodiments, the double-sided pad conditioner assembly 10 does not contact the one or more surface modifications directly. In some embodiments, the double-sided pad conditioner assembly 10 can contact one or more of the one or more surface modifications directly. In some embodiments, direct contact may create manufacturing challenges due to required flatness of the corresponding components.

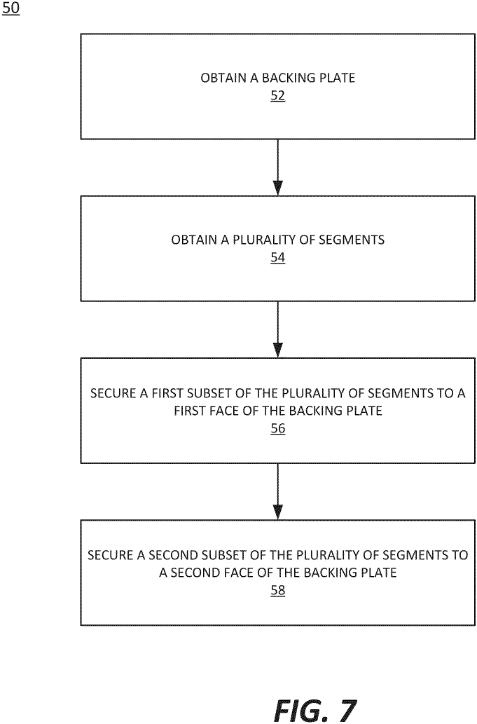

FIG. 7 shows a flowchart of a method 50 for manufacturing the double-sided pad conditioner assembly according to some embodiments. The method 50 can be used with the embodiments of, for example, FIG. 3. For simplicity of this Specification, features previously described will not be described in additional detail unless specific reference is made.

The method 50 includes obtaining a backing plate at block 52. The backing plate can be the backing plate 12 of FIGS. 1A-4 or 6, for example. The method includes obtaining a plurality of segments at block 54. In some embodiments, the segments can be the segments 14 such as the segments 14A and 14B in FIGS. 2A-4 and 6 above. The method includes securing a first subset of a plurality of segments (14A) to a plurality of first mounting locations at block 56. The method includes securing a second subset (14B) of the plurality of segments to a plurality of second mounting locations at block 58.

In some embodiments, the securing the second subset of the plurality of segments at block 58 is completed after the securing the first subset of the plurality of segments to the plurality of first mounting locations at block 56. It is to be appreciated that the first order can be reversed (i.e., block 58 being performed before block 56).

In some embodiments, block 58 can include aligning the second subset of the plurality of segments on a mounting guide. An adhesive can be applied to the second subset of the plurality of segments. Block 58 can further include applying a force to the second surface of the backing plate. In some embodiments, a guide plate can be disposed between the backing plate and a surface applying the force to the second surface of the backing plate to prevent contact with the surface applying the force to the second surface of the backing plate and the first subset of the plurality of segments. In some embodiments, the mounting guide can be used to ensure that the first segments and the second segments are aligned in the same positions of the backing plate on opposite faces of the backing plate.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A chemical mechanical planarization (CMP) pad conditioner assembly, comprising:
a backing plate, the backing plate comprising:
a first face and a second face, wherein the first face includes a plurality of first mounting locations and wherein the second face includes a plurality of second mounting locations,
a plurality of segments secured to the first face at the plurality of first mounting locations, wherein each of the plurality of segments comprises:
a substrate having a first surface and a second surface, wherein the first surface is opposite the second surface; and
a plurality of protrusions integral with the substrate protruding away from the first surface, wherein the plurality of protrusions is coated with a conformal diamond layer, and
a plurality of second segments secured to the second face at the plurality of second mounting locations, wherein each of the plurality of second segments includes:
a substrate having a first surface and a second surface, wherein the first surface is opposite the second surface;
a plurality of protrusions integral with the substrate protruding away from the first surface, wherein the plurality of protrusions is coated with a conformal diamond layer.

2. The assembly of claim 1, wherein the backing plate comprises stainless steel.

3. The assembly of claim 1, wherein the backing plate comprises a polymer.

4. The assembly of claim 3, wherein the backing plate is made from an additive manufacturing process.

5. The assembly of claim 3, wherein the backing plate is injection molded.

6. The assembly of claim 3, wherein the polymer includes metallic particulate fillers.

7. The assembly of claim 3, wherein one or more of the first plurality of mounting locations or the second plurality of mounting locations are recessed into the backing plate.

8. The assembly of claim 1, wherein one or more of the first plurality of mounting locations or the second plurality of mounting locations are recessed into the backing plate and comprise a well recessed into the backing plate.

9. The assembly of claim 8, wherein the well comprises one or more surface modifications.

10. A chemical mechanical planarization (CMP) pad conditioner assembly, comprising:
a backing plate, the backing plate, comprising:
a first face and a second face;
a plurality of mounting locations;
a well in each of the plurality of mounting locations and recessed into the backing plate; and
a plurality of segments secured to the backing plate at the plurality of mounting locations, wherein each of the plurality of segments comprises:
a substrate having a first surface and a second surface, wherein the first surface is opposite the second surface;
a plurality of protrusions integral with the substrate and protruding away from the first surface; wherein the plurality of protrusions is coated with a conformal diamond layer; and
a second plurality of protrusions integral with and protruding away from the second surface, wherein the second plurality of protrusions is coated with a conformal diamond layer;
wherein the well in each of the plurality of mounting locations has a smaller surface area than the plurality of segments secured to the backing plate at the plurality of mounting locations.

11. The assembly of claim 10, wherein the backing plate comprises stainless steel.

12. The assembly of claim 10, wherein the backing plate comprises a polymer.

13. The assembly of claim 12, wherein the backing plate is made from an additive manufacturing process.

14. The assembly of claim 10, wherein the plurality of mounting locations are apertures in the backing plate.

15. The assembly of claim 10, wherein each of the plurality of segments is the same.

16. A method, comprising:
obtaining a backing plate, wherein the backing plate comprises:
a first face and a second face, wherein the first face includes a plurality of first mounting locations and wherein the second face includes a plurality of second mounting locations;
obtaining a plurality of segments, wherein the plurality of segments comprises:
a substrate having a first surface and a second surface, wherein the first surface is opposite the second surface;
a plurality of protrusions integral with the substrate protruding away from the first surface, wherein the plurality of protrusions is coated with a conformal diamond layer;
securing a first subset of the plurality of segments to the plurality of first mounting locations; and
securing a second subset of the plurality of segments to the plurality of second mounting locations.

17. The method of claim 16, wherein securing the first subset of the plurality of segments includes:
aligning the first subset of the plurality of segments on a mounting guide;
applying an adhesive to the second surface of the first subset of the plurality of segments; and
applying a force to the second face of the backing plate.

18. The method of claim 16, wherein the securing the second subset of the plurality of segments is completed after the securing the first subset of the plurality of segments to the plurality of first mounting locations.

19. The method of claim 18, wherein securing the second subset of the plurality of segments includes:
aligning the second subset of the plurality of segments on a mounting guide;
applying an adhesive to the second surface of the second subset of the plurality of segments; and
applying a force to the second surface of the backing plate,
wherein a guide plate is disposed between the backing plate and a surface applying the force to the second surface of the backing plate to prevent contact with the surface applying the force to the second surface of the backing plate and the first subset of the plurality of segments.

20. The method of claim 16, wherein a mounting guide is used for securing the first subset of the plurality of segments and the second subset of the plurality of segments so that the first subset of the plurality of segments and the second subset of the plurality of segments are installed in a same location on opposite surfaces of the backing plate.
